(19) United States
(12) Patent Application Publication
(10) Pub. No.: US 2011/0181433 A1
(43) Pub. Date: Jul. 28, 2011

(54) ACOUSTIC WAVE PROBE

(75) Inventor: Takatoshi Tanaka, Tokyo (JP)

(73) Assignee: CANON KABUSHIKI KAISHA, Tokyo (JP)

(21) Appl. No.: 13/008,499

(22) Filed: Jan. 18, 2011

(30) Foreign Application Priority Data
Jan. 26, 2010 (JP) 2010-014052

(51) Int. Cl. G08B 21/00; G05D 16/00

(52) U.S. Cl. 340/665; 700/301

(57) ABSTRACT

An acoustic wave probe which includes an acoustic wave conversion element which receives an acoustic wave, a liquid-tightly sealed protecting unit which contains the acoustic wave conversion element, a portion of the protecting unit being an acoustic wave transmitting part having high acoustic wave transmittance, a detecting unit which detects a flexure amount denoting a degree of deformation of the protecting unit, and a notifying unit which notifies whether the flexure amount detected by the detecting unit is larger than a predetermined value.

### BACKGROUND OF THE INVENTION

1. Field of the Invention

The present invention relates to an acoustic wave probe.

2. Description of the Related Art

A configuration has been proposed to protect an acoustic wave conversion element in an acoustic wave probe, in which the element is configured to receive an acoustic wave (typically, ultrasonic wave) and convert it into an electric signal.

For example, an acoustic wave probe disclosed in Japanese Patent Application Laid-Open No. 2006-094459 includes a protecting unit configured to protect an acoustic wave conversion element therein, and the protecting unit is filled with a liquid, sol or gel. Further, it is disclosed that the protecting unit is partially constituted of a thin member like a film. By constituting the protecting unit of the thin member, this unit can transmit the acoustic wave easily.

### SUMMARY OF THE INVENTION

If the protecting unit is constituted of a thin member to provide an acoustic wave transmitting part as disclosed in Japanese Patent Application Laid-Open No. 2006-094459, the acoustic wave transmitting part may flex and come in contact with the acoustic wave conversion element to apply a load on them. As a result, an issue would occur in that the conversion characteristics of the acoustic wave transmitting part might change.

In view of the above, the present invention has been developed, and it is an object of the present invention to provide an acoustic wave probe that can prohibit an acoustic wave transmitting part and an acoustic wave conversion element from coming in contact with each other while keeping improved acoustic transmittance.

An acoustic wave probe according to this invention comprising:

an acoustic wave conversion element which receives an acoustic wave and converts the acoustic wave into an electric signal;

a protecting unit which is sealed liquid-tightly and contains the acoustic wave conversion element, a portion of the protecting unit being an acoustic wave transmitting part that has a higher acoustic wave transmittance than the other portions;

a detecting unit which detects a flexure amount denoting a degree of deformation of the protecting unit; and

a notifying unit which notifies whether the flexure amount detected by the detecting unit is larger than a predetermined value.

Another acoustic wave probe according to this invention comprising:

an acoustic wave conversion element which receives an acoustic wave and converts the acoustic wave into an electric signal;

a protecting unit which is sealed liquid-tightly and contains the acoustic wave conversion element, a portion of the protecting unit being an acoustic wave transmitting part that has a higher acoustic wave transmittance than the other portions;

a detecting unit which detects a flexure amount denoting a degree of deformation of the protecting unit from a change of pressure in the protecting unit; and

a pressure adjusting unit which increases the pressure in the protecting unit if the flexure amount detected by the detecting unit is larger than a predetermined value.

According to the present invention, it is possible to provide an acoustic wave probe that can prohibit an acoustic wave transmitting part and an acoustic wave conversion element from coming in contact with each other while keeping improved acoustic transmittance.

Further features of the present invention will become apparent from the following description of exemplary embodiments with reference to the attached drawings.

### BRIEF DESCRIPTION OF THE DRAWINGS

FIG. 1A is an external view of an acoustic wave probe and FIG. 1B is its cross-sectional view;

FIG. 2A is a plan view of an acoustic wave conversion element and FIG. 2B is its cross-sectional view;

FIG. 3 is a cross-sectional view of the acoustic wave probe according to a first embodiment;

FIG. 4 is a cross-sectional view of the acoustic wave probe according to a second embodiment; and

FIG. 5 is a cross-sectional view of the acoustic wave probe according to a third embodiment.

### DESCRIPTION OF THE EMBODIMENTS

According to the present invention, acoustic waves include elastic waves referred to as sound waves, ultrasonic waves, and photo-acoustic waves. An acoustic wave probe according to the present invention is well suited for an application as an acoustic wave probe which is used in condition where its acoustic wave reception surface is attached firmly to an object to be measured. Specifically, the acoustic wave probe can be used in photo-acoustic tomography for applying light to the inside of a test organ and receiving an acoustic wave (typically, ultrasonic wave) generated in it to display its tissue image. The acoustic wave probe can be used also in a diagnostic device etc. by use of an ultrasonic echo for transmitting an ultrasonic wave to and receiving it from the inside of a test organ to display its tissue image. Amore specific example may be a handheld acoustic wave probe applied in the medical field.

In the case of using the acoustic wave probe as a handheld type, its acoustic wave conversion element is put into a package to prevent it from being damaged.

The following will describe an embodiment of the present invention with reference to the drawings.

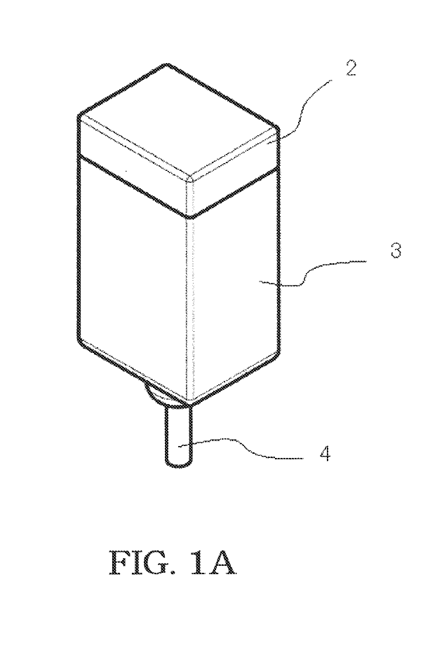

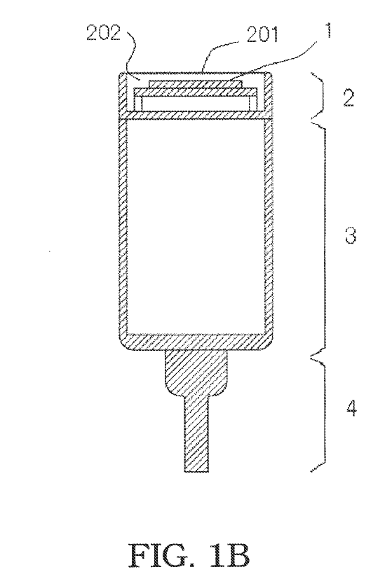

FIGS. 1A and 1B outline an embodiment of the present invention. FIG. 1A shows the external view of the device and FIG. 1B shows its cross-sectional view.

The acoustic wave probe includes an acoustic wave conversion element 1 for converting an acoustic wave into an electric signal, a protecting unit 2 configured to protect the acoustic wave conversion element, a grip unit 3 for supporting the device during measurement, and a cable unit 4 for transmitting the electric signal obtained from the acoustic wave conversion element.

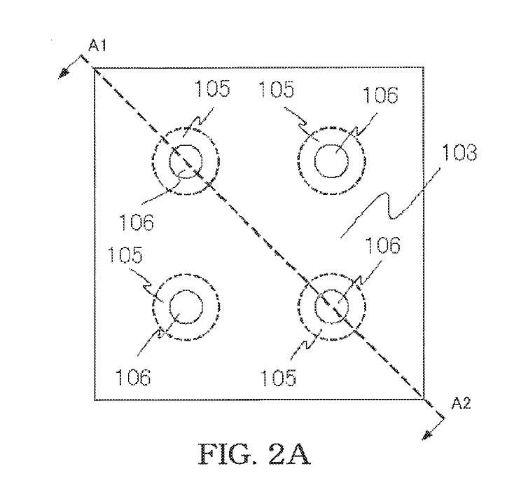

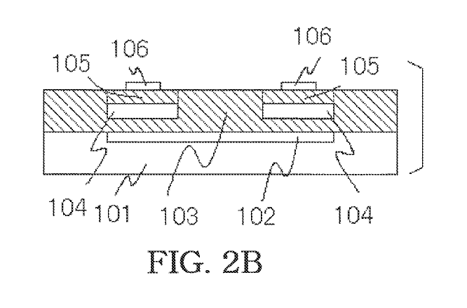

As the acoustic wave conversion element 1, for example, a capacitance type one can be used. The capacitance type acoustic wave conversion element uses a light-weight vibrating membrane. A description will be given of a structure of the capacitance type acoustic wave conversion element with reference to FIGS. 2A and 2B. FIG. 2A is its plan view and FIG. 2B is its cross-sectional view.

The capacitance type acoustic wave probe includes a substrate 101, a lower electrode 102, a supporting part 103, a void part 104, a vibrating part 105, and an upper electrode 106. The lower electrode and the supporting part are disposed on the principal surface of the substrate, while the vibrating part having the upper electrode is supported by the supporting part via the void part between the substrate and the lower electrode in such a manner that it can vibrate. The principal surface as referred to here denotes one of the acoustic wave probe surfaces that faces an object to be measured. If an acoustic wave emitted from the object to be measured impinges on the vibrating part 105, the vibrating part 105 vibrates in response to the acoustic wave. In this case, if a bias voltage from a DC voltage supply is applied beforehand between the lower electrode 102 and the upper electrode 106, a current signal corresponding to the vibration of the vibrating part occurs, so that by measuring this current signal, waveforms of the acoustic wave signal can be obtained.

Description will be continued with reference to FIGS. 1A and 1B. The protecting unit 2 is structured in such a manner that it may contain the acoustic wave conversion element. One portion of it that faces the principal surface of the acoustic wave conversion element should preferably be constituted of a member that is thinner (for example, 10-900 μm) than the other portions so that it may transmit acoustic waves. The portion constituted of the thin member is defined to be an acoustic wave transmitting unit 201. By equipping the acoustic wave transmitting part, it is possible to inhibit reflection of sounds by the member, thereby receiving acoustic waves efficiently.

Avoid 202 in the protecting unit should preferably be filled with a liquid, sol, gel, etc. By doing so, it is possible to inhibit sound reflections due to a difference in acoustic impedance between the protecting unit and the void, thereby receiving acoustic waves efficiently.

As the acoustic wave conversion element 1, a piezoelectric conversion element or photo-resonant conversion element may be used besides the capacitance type one. Any acoustic wave conversion element may be used as long as it can receive an acoustic wave and convert it into an electric signal. By disposing a plurality of the acoustic wave conversion elements one-dimensionally or two-dimensionally, it is possible to receive acoustic waves at a plurality of positions simultaneously, thereby reducing a lapse of time required in reception and an influence by the vibrations of a test organ.

### First Embodiment

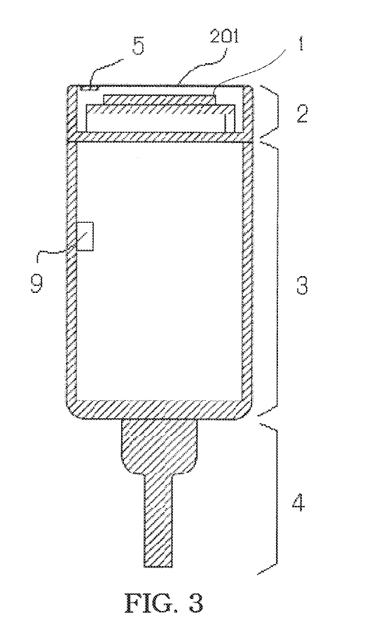

FIG. 3 is the cross-sectional view of an acoustic wave probe according to a first embodiment. The acoustic wave probe according to the first embodiment includes an acoustic wave conversion element 1 for converting an acoustic wave into an electric signal, a protecting unit 2 configured to protect the acoustic wave conversion element by containing it, a grip unit 3 for supporting the device during measurement, and a cable unit 4 for transmitting the electric signal obtained from the acoustic wave conversion element. The acoustic wave probe further includes a flexure amount detecting unit (detecting unit) configured to be installed in the protecting unit in order to detect a flexure amount denoting a degree of deformation of this protecting unit and a flexure gauge 9 (notifying unit) for notifying the user of a flexure amount. A portion of the protecting unit is constituted of a thin member, which provides an acoustic wave transmitting part 201. The protecting unit 2 contains the acoustic wave conversion element 1 and should preferably be sealed liquid-tightly in condition where its void is filled with a liquid, sol, or gel.

As the flexure amount detecting unit 5, a strainmeter is installed to the acoustic wave transmitting part 201 in the protecting unit 2. If the acoustic wave transmitting part 201 flexes due to external force applied on the acoustic wave transmitting part 201, the strainmeter measures its flexure amount as a change in voltage. Then, the flexure amount detecting unit 5 detects whether the flexure amount of the acoustic wave transmitting part 201 is larger than a predetermined value.

The flexure gauge 9 has a function to notify the user if the flexure amount is larger than the predetermined value. The flexure gauge 9 can notify the user of it by using a buzzer, vibrations, or a lamp. If notified of it, the user can adjust an imposing pressure on the gauge corresponding to its position, to prevent the acoustic wave transmitting part 201 from coming in contact with the conversion element 1.

By using such an acoustic wave probe as in the present embodiment, even if the portion of the protecting unit is constituted of a thin member like a film, it is possible to detect whether a flexure amount is within a predetermined range so that the user may be prompted for adjustment. With this, it is possible to conduct reliable measurement with a less change in conversion characteristics by preventing the acoustic wave conversion element from being bent while inhibiting the reflection of acoustic waves to improve transmittance.

### Second Embodiment

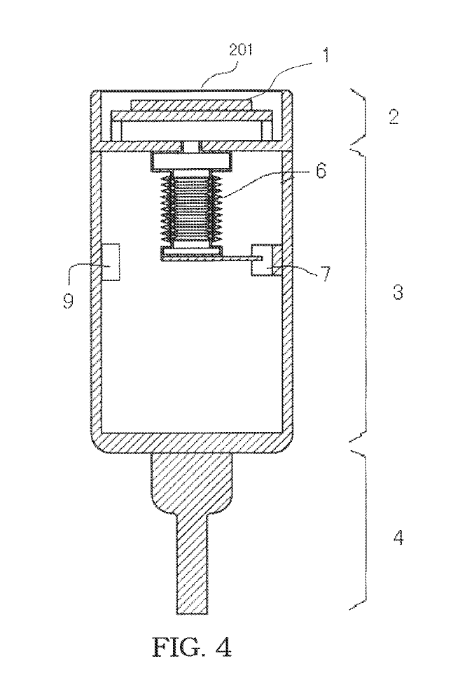

FIG. 4 is the cross-sectional view of an acoustic wave probe according to a second embodiment. The acoustic wave probe includes an acoustic wave conversion element 1 for converting an acoustic wave into an electric signal, a protecting unit 2 configured to protect the acoustic wave conversion element, a grip unit 3 for supporting the device during measurement, and a cable unit 4 for transmitting the electric signal obtained from the acoustic wave conversion element. A portion of the protecting unit is constituted of a thin member, which provides an acoustic wave transmitting part 201. The acoustic wave probe according to the present embodiment further includes a reserve tank 6 connected to the protecting unit 2 and made of an elastic deformation material, flexure amount detecting unit 7 configured to detect an elastic deformation (flexure amount) of the reserve tank, and a flexure gauge 9 for notifying the user of a flexure amount.

As the reserve tank 6, for example, a bellows-shaped member should preferably be used so that it may be deformed along one axis in response to a flexure amount of the acoustic wave transmitting part 201. The reserve tank 6 can be constituted of a bellows pressure indicator that is deformed in response to any change in pressure in the protecting unit if, for example, the acoustic wave transmitting part 201 is deformed and flexes. Further, by constituting the flexure amount detecting unit 7 of a meter configured to measure the deformation, the flexure amount of the acoustic wave transmitting part 201 can be measured.

The flexure gauge 9 has a function to notify the user if the deformation (flexure amount) of the reserve tank is not within a predetermined range. The flexure gauge 9 can notify the user of it by using a buzzer, vibrations, or a lamp. If notified of it, the user can adjust an imposing pressure on the gauge corresponding to its position, to prevent the acoustic wave transmitting part 201 from coming in contact with the conversion element 1. With this, it is possible to conduct reliable measurement with a less change in conversion characteristics by preventing the acoustic wave conversion element from being bent while inhibiting the reflection of acoustic waves to improve transmittance.

### Third Embodiment

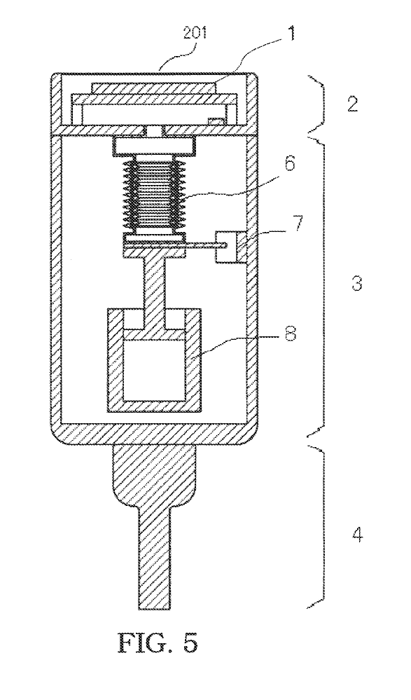

FIG. 5 is a cross-sectional view of an acoustic wave probe according to a third embodiment. The acoustic wave probe includes an acoustic wave conversion element 1 for converting an acoustic wave into an electric signal, a protecting unit 2 configured to protect the acoustic wave conversion element, a grip unit 3 for supporting the device during measurement, and a cable unit 4 for transmitting the electric signal obtained from the acoustic wave conversion element. A portion of the protecting unit is constituted of a thin member, which provides an acoustic wave transmitting part 201. The acoustic wave probe further includes a reserve tank 6 connected to the protecting unit 2 and made of an elastic deformation material, a pressure detecting unit 7 configured to detect a pressure in the protecting unit, and a pressure adjusting unit 8 configured to adjust the pressure in the protecting unit in response to a measured flexure amount.

The reserve tank 6 is constituted of, for example, a bellows-shaped member. The bellows-shaped member is deformed along one axis if the acoustic wave transmitting part 201 flexes in response to a pressure in the protecting unit. By measuring the deformation, the pressure detecting unit 7 can measure a flexure amount of the acoustic wave transmitting part 201 in response to a pressure in the protecting unit.

The pressure adjusting unit 8 has a function to adjust the pressure in the protecting unit in response to a flexure amount measured by the pressure detecting unit 7. That is, if a flexure amount outside the predetermined range is detected, it increases the pressures in the respective reserve tank 6 and protecting unit 2, thereby inhibiting the flexure due to external force. As the pressure adjusting unit, for example, a piston and a cylinder can be used, so that the pressure can be adjust by adjusting the position of the piston within the cylinder in response to an output from the pressure detecting unit 7.

In this case, it is necessary to set the pressure in the protecting unit 2 into such a range that the upper electrode and the lower electrode in the acoustic wave conversion element 1 may not come in contact with each other owing to a pressure. If the upper and lower electrodes come in contact with each other, measurement is difficult to carry out.

By providing such functions, it is possible to conduct reliable measurement with a less change in conversion characteristics by preventing the acoustic wave conversion element from being bent while inhibiting the reflection of acoustic waves to improve transmittance.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-014052, filed on Jan. 26, 2010, which is hereby incorporated by reference herein its entirety.

What is claimed is:

1. An acoustic wave probe comprising:
an acoustic wave conversion element which receives an acoustic wave and converts the acoustic wave into an electric signal;
a protecting unit which is sealed liquid-tightly and contains the acoustic wave conversion element, a portion of the protecting unit being an acoustic wave transmitting part that has a higher acoustic wave transmittance than the other portions;
a detecting unit which detects a flexure amount denoting a degree of deformation of the protecting unit; and
a notifying unit which notifies whether the flexure amount detected by the detecting unit is larger than a predetermined value.

2. The acoustic wave probe according to claim 1, wherein the detecting unit is a strain meter for detecting a flexure of the acoustic wave transmitting part.

3. The acoustic wave probe according to claim 1, wherein the detecting unit detects a change of pressure in the protecting unit.

4. The acoustic wave probe according to claim 3, wherein the detecting unit is bellows connected to the protecting unit and deformed in response to a pressure in the protecting unit.

5. An acoustic wave probe comprising:
an acoustic wave conversion element which receives an acoustic wave and converts the acoustic wave into an electric signal;
a protecting unit which is sealed liquid-tightly and contains the acoustic wave conversion element, a portion of the protecting unit being an acoustic wave transmitting part that has a higher acoustic wave transmittance than the other portions;
a detecting unit which detects a flexure amount denoting a degree of deformation of the protecting unit from a change of pressure in the protecting unit; and
a pressure adjusting unit which increases the pressure in the protecting unit if the flexure amount detected by the detecting unit is larger than a predetermined value.

6. The acoustic wave probe according to claim 5, wherein the detecting unit is bellows connected to the protecting unit and deformed in response to a pressure in the protecting unit.

7. The acoustic wave probe according to claim 5, wherein the pressure adjusting unit comprised of a piston and a cylinder connected to the protecting unit, to adjust the pressure by adjusting a position of the piston in the cylinder.
